(19) United States
(12) Patent Application Publication
(10) Pub. No.: US 2006/0292264 A1
(43) Pub. Date: Dec. 28, 2006

(54) Production of fermented palm kernel cake (PKC)

(75) Inventors: Choi Hun Young, Donggongon (MY); Reynard Gondipon, Donggongon (MY)

Correspondence Address: PALMER & DODGE, LLP;KATHLEEN M. WILLIAMS, 111 HUNTINGTON AVENUE, BOSTON, MA, 02199, US

(73) Assignee: QL AgrobioSdn. Bhd.

(21) Appl. No.: 11/217,527

(22) Filed: Sep. 1, 2005

(30) Foreign Application Priority Data
Jun. 22, 2005 (MY) PI 2005 2841

(51) Int. Cl. A23L 1/23

(52) U.S. Cl. 426/33

(57) ABSTRACT

The present invention related to a bioprocess method of producing fermented of Palm Kernel Cake (PKC). The present invention is to enhance the nutritive value of PKC for animal feed by breaking down mannan fiber in raw PKC using Bacillus megaterium combined with Lactobacillus sp.

### RELATED APPLICATIONS

This application is a claims priority under 35 USC § 119 to a Malaysian application PI 2005 2841 filed 22 Jun. 2005, the entirety of which is incorporated herein by reference.

### FIELD OF INVENTION

The present invention relates to a bioprocess method of producing fermented Palm Kernel Cake. More particularly, the invention relates to the use of fermented Palm Kernel Cake as a feed component, for example, for monogastric animals.

### BACKGROUND OF INVENTION

Malaysia is the world's leading palm oil producer, producing approximately 14 million metric tons of palm oil and about 2 million ton of palm kernel cake in 2004. Palm Kernel Cake (PKC) is a residue from palm kernel oil extraction process. Palm Kernel Cake is also known as Palm kernel expeller. The European Union countries are the major importer of palm kernel cake, used as an additional nutrient for cattle feed. PKC is used as a nutrient additive in the swine feed. The main composition of PKC consists of about 15% to 18% protein and 60% to 70% polysaccharide, with a moisture content of 7.0% to 12%. PKC is not widely used in poultry diets due to its high content of non-starch polysaccharides (NSPs). The major NSPs are mannan, particularly β-mannan type hemicellulose. The presence of NSPs reduces the feed and nutrient conversion efficiency in monogastric animal feed.

PKC is an excellent feed for ruminants. However, the utilization of PKC in non-ruminants, especially poultry are restricted due to highly indigestible fiber content. Mannan polymers in PKC fiber are highly crystalline, insoluble and does not depolymerise in digestive tract of poultry.

Mannanase was reported to be an effective enzyme in that can improve the nutritive value in PKC. There are three known mannanase enzymes i.e., endo-β mannanase, exo-β mannanase and β-mannosidase that can be used to decompose and convert the mannan, which is a principal component of hemicellulose. Mannanase is a promising enzyme for decomposing component constituting hemicellulose.

Mannanase enzyme is produced by mold, yeast or fungus and bacteria such as Bacillus sp, Aeromonas, Enterococcus, Pseudomonas and others. Some higher plants or animals can also produce mannanase.

The present invention places great importance on the production of fermented Palm Kernel Cake (PKC) for monogastric animal feed. The inventors of this invention use a Solid Substrate Fermentation (SSF) for the production of mannanase. Through this invented bioprocess, processed PKC can be applied for monogastric animal feed formulation at a higher inclusion rate.

The major factors that affect microbial synthesis of enzymes in a SSF system include: selection of a suitable substrate and microorganism; pre-treatment of the substrate; particle size (inter-particle space and surface area) of the substrate; water content; relative humidity; type and size of the inoculums; control of temperature of fermenting matter/removal of metabolic heat; period of cultivation; maintenance of uniformity in the environment of SSF system and the gaseous atmosphere, i.e. oxygen consumption rate and carbon dioxide evolution rate.

The interest in SSF can be explained by various advantageous features: favorable ecological conditions for the microorganisms, low drying costs, no polluting residues, fungal spores (for bio-pesticides) are easily produced, inert, reusable carriers can be applied.

### SUMMARY OF THE INVENTION

This invention discloses a bioprocess method of producing fermented Palm Kernel cake (PKC) in a Solid Substrate Fermentation. The method comprises the steps of providing separate cultures of Bacillus megaterium and Lactobacillus sp., mixing the separate cultures with Palm Kernel Cake at a pH between 5 and 7.5 to produce a mixture, and curing the mixture to produce fermented Palm Kernel Cake. The invention also discloses animal feed comprising such fermented Palm Kernel Cake. The feed can be useful, for example, for feeding monogastric animals.

### DETAILED DESCRIPTION OF THE INVENTION

Accordingly, the objective of the present invention is to enhance the nutritive value of PKC, for example, for monogastric animals, by breaking down mannan fiber in raw PKC using Bacillus megaterium combined with Lactobacillus sp. Another objective of the present invention is to provide a method for commercial production of fermented PKC through mannanase enzyme using Bacillus megaterium combined with Lactobacillus sp. in Solid Substrate Fermentation, whereby PKC is used as a solid substrate. Most Bacillus species are versatile and capable of respiration using a variety of simple organic compounds (sugars, amino acids, organic acids).

In general, the present invention comprises three steps: (1) production of microbes, (2) mixing of microorganisms with PKC and (3) curing and drying of fermented PKC.

In one aspect, the invention provides a method of producing fermented Palm Kernel cake (PKC) in a Solid Substrate Fermentation. The method comprises the steps of providing separate cultures of Bacillus megaterium and Lactobacillus sp., mixing the cultures with Palm Kernel Cake at a pH between 5 and 7.5 to produce a mixture, and curing the mixture to produce fermented Palm Kernel Cake.

In another aspect, the invention provides a method of producing dried fermented Palm Kernel cake (PKC) in a Solid Substrate Fermentation. The method comprises the steps of:
a) separately activating stocks of Bacillus megaterium and Lactobacillus sp,
b) separately culturing Bacillus megaterium and Lactobacillus sp.,
c) obtaining separate first seed stock cultures of Bacillus megaterium and Lactobacillus sp. from step (b);
d) utilizing separate the first seed stock cultures of Bacillus megaterium and Lactobacillus sp. from step (c) for second seeding or multiplying process to obtain second seed stock cultures;
e) mixing the second seed stock cultures with raw PKC and maintaining the pH range between 5 to 7.5 to produce a fermented PKC;
f) curing the fermented PKC to produce a cured fermented PKC; and
g) drying the cured PKC from to yield a dried fermented Palm Kernel Cake.
   (1) Production of Microbes

The production of the microbes is conducted in three steps that consist of stock activation, first seeding and second seeding (multiplying) of microorganisms. In the stock activation process, the microbes (Bacillus megaterium and Lactobacillus sp.) are planted or slanted independently on a nutrient agar media for 24 hours. In the first seeding process, the microorganisms are inoculated inside a nutrient broth media. In one embodiment, the content of materials in the nutrient agar media consists of 20 gram of agar, 5 gram of nutrient broth and 395 ml of water, whereas, the nutrient broth media consists of 8 g of nutrient broth and 692 ml of water. The Bacillus megaterium can be obtained from fermented soya bean paste and the Lactobacillus sp. can be obtained from yogurt.

The method of preparing the nutrient agar media, activation and culturing of microorganisms are well established. It should be understood that any method of culturing Bacillus megaterium or Lactobacillus sp., known in the art, can be used. The culturing of the microorganisms is established independently in a liquid nutrient broth. The liquid nutrient broth containing microbes culture is known as a first seed stock culture. The first seed stock culture will be used for further fermentation process i.e. Second seeding or multiplying process.

The second seeding or multiplying process can be carried out using two methods, either by a conventional process or a non-conventional process.

In the conventional process, the second seeding of Bacillus megaterium or Lactobacillus sp. is done independently. A fermenter is used in the conventional process, whereby air is supplied through an inlet hose. In this process a working stock containing either Bacillus megaterium or Lactobacillus sp. is grown in media comprising: glucose, ammonium sulfate, potassium phosphate (monobasic) and (dibasic), any water-soluble autolysis yeast extract, stock containing microbes (Bacillus megaterium and/or Lactobacillus sp), water, foam control agent and/or ammonium water. In one embodiment, the second seed stock cultures of Bacillus megaterium and Lactobacillus have a final concentration, or “working range,” of between 0.7% and 0.9% [v/v], for example, 0.7, 0.75, 0.8, or 0.85% [v/v]. The glucose concentration is typically between 2% and 3% [w/v], for example 2, 2.5, or 3% [w/v]. Ammonium sulfate can be added at a final concentration of between about 0.2% and 0.4% [w/v], for example, 0.2, 0.25, 0.3, or 0.35% [w/v]. Potassium phosphate (monobasic) has a typical final concentration of between 0.1% and 0.3% [w/v], for example, 0.15, 0.2, or 0.25% [w/v]. In addition, potassium phosphate (dibasic) typically has a final concentration of between 0.09% and 0.2% [w/v], for example, 0.1, 0.125, 0.15, or 0.175% [w/v]. Water soluble yeast extract can be added at a final concentration of between 0.2% and 0.4% [w/v] (e.g., 0.25%, 0.3%, or 0.35% [w/v]). Water content can range between 91% to 98% [v/v], for example 92, 93, 94, 95.4, 96.1, 97, or 98% [v/v]. Foam control agents can be added at a final concentration of at least 15%, for example at 20%, 30%, 40% or more. Peptone can be added to a final concentration (“working stock) of between 0.05% to 0.015% [w/v], for example, 0.05, 0.075, 0.1, 0.125, or 0.15% [w/v].

The ammonium water, which can be added at 1%, 2%, 5%, 10%, 20% [v/v] or more, is used to regulate the fermentation of foam during the second seeding process, as well as the pH value of the working stock. The following is performed with a pH range of 5 to 7.5. At the time of this process, ammonium water is injected into the working stock to maintain the pH. By this process, Bacillus megaterium or Lactobacillus sp. seed is obtained.

In the non-conventional process of the second seeding, a glass container with an aeration kit is used. The fermentation of Bacillus megaterium or Lactobacillus sp. is prepared independently. A working stock is prepared comprising of glucose, ammonium sulfate, and potassium phosphate (monobasic) and (dibasic), water soluble yeast extract, microbes (Bacillus megaterium or Lactobacillus sp), and foam control agent. The following process is performed with an air supply through an aeration kit from the first day of the fermentation process. The following is performed with a pH range of 5 to 7.5. First seed stock culture of Bacillus megaterium and/or Lactobacillus can be added to a final concentration of between 0.07% and 0.09% [v/v], for example, 0.08% [v/v]. Glucose can be added to a final concentration of between 1% and 2% [w/v], for example, 1.2, 1.4, 1.6, or 1.8% [w/v]. Ammonium sulfate can be added to a final concentration of between 0.1% and 0.2% [w/v], for example, 0.12, 0.14, 0.16, or 0.18% [w/v]. The potassium phosphate (monobasic) can be added to the culture at a final concentration of between 0.03% and 0.05% [w/v], for example, at 0.04% [w/v]. The culture can also comprise potassium phosphate (dibasic) at a final concentration of between about 0.03% and 0.04% [w/v], for example, 0.035% [w/v]. In addition, water soluble yeast extract can be added to the seed stock culture at a final concentration of between 0.04% and 0.06% [w/v], for example, 0.05% [w/v]. Water in the stock culture can range between 93% and 99% [v/v], for example, 98.56% [v/v]. In addition, a foam control agent can be added to a final concentration of between about 0.03% and 0.05% [v/v], for example, 0.04% [v/v]. The stock culture can comprise peptone at final concentration of between 0.06% and 0.15% [v/v], for example 0.9%.

The seeding through the above fermentation process will be completed between 16-22 hours and the working stock is ready to be used for mixing. The chemically defined media used for seeding (non-conventional) is basically for economic consideration that will provide the best and optimum population of the working stock at a very minimum cost of production.

The purpose of multiplying (second seeding) the microbes (Bacillus megaterium and Lactobacillus sp.) separately is to ensure the working stock population and purity of the said microbes are safe guarded before mixing with the PKC substrate. After fermentation, the purity of the culture is checked using methods known to the art. This is to ensure the fermented microorganisms are not contaminated. Population check analysis is also required.

2) Mixing of Microorganisms with PKC

Before the mixing process, raw PKC is reduced to a suitable size preferably 5 mm diameter granules. The reduction of size of PKC is to provide a furthermost action with the microorganism. In the mixing step, the microorganisms are mixed with raw PKC to allow the resultant mixture to ferment. In the mixing process, pH, air, moisture content and temperature needs to be regulated. Fermented PKC is produced using, of raw PKC, Bacillus megaterium seed and Lactobacillus sp. seed, a pH regulator (e.g., ash) and initial water content of between 27% to 60%, for example, between 27% and 49% [v/w], or at 28.7% [v/w]. Raw PKC can be added to final concentration of between 65% and 72% [w/w] in the mixture, for example, 68% [w/w]. The microbes are mixed using a horizontal mixer at the speed of 7-15 rpm to reach homogeneity with a minimum period of 15 minutes. The Bacillus megaterium and Lactobacillus sp. seed are added to the mixture at final concentration of between 0.2% and 0.5% [v/w] for each seed, for example, 0.34% [v/w].

The working pH range is between 5 and 7.5. pH can be adjusted using any commonly available base, for example NaOH, Ca(OH)₂, KOH, ammonium, and/or ash. In one embodiment, ash is used to adjust the pH. Ash can be added to the mixture at a final concentration of between 1% and 4% [w/w], for example, 2.05% [w/w]. The utilization of ash allows the inventor to obtain the above pH requirement. The application of ash is a cheap source of alkaline for pH control of the fermenting mixture. Ash can be obtained from any organic residue when it is burnt such as, paddy husk ash, oil palm empty fruit bunch ash and oil palm empty fruit bunch. In one embodiment, the ash is from a boiler chamber (boiler ash) of palm oil mills and oil palm empty fruit bunch.

(3) Curing and Drying of Mixed PKC

The curing and drying process is performed as follows: The purpose of the curing process is to acquire a pro-biotic function and to produce mannanase. In one embodiment, the curing process is performed indoors under ambient conditions, in order to have a stabilized curing without any effect by the weather. A ventilated house or compartment is required for indoor curing and drying process. By having a well ventilated house, the temperature is controlled and the drying of fermented PKC can be accelerated

The mixed PKC is packed into either bag or other substitutable packaging means. In one embodiment, the mixed PKC is packed into bags, and the bags were then placed on to wooden slats in a ventilated house. It is ensured that the thickness of the mixed PKC when laid out in the bag is less than 20 cm. The bags are turned at least 2-3 times per day. The purpose of turning the bags is to maintain the temperature of the fermented mixture between 45° C. to 60° C. and also to assist in the drying process. The curing and drying process generally requires about 7 to 14 days and the final water content of the product is about 12% or less.

This method can also provide the technical opportunity to be expanded to industrial scale using concrete bay type of composting, where the maximum thickness of the substrate can be up to 100 cm or more. This invention provides many options of using non-conventional methods that is relatively cheap and easily available.

In the present invention, the processed PKC produced by Bacillus megaterium combined with Lactobacillus sp. is useful in the feed industry. Through the invented bioprocess, the fermented PKC could be applied for monogastric animal feed. Thus, the fermented PKC can be a partial substitute particularly for corn and soya bean in the feed industry.

The present invention will be described by way of the following examples, which do not limit the scope of the present invention.

### EXAMPLES

### Example 1

Determination of Characteristics of Bacillus megaterium

Characteristics of Bacillus megaterium

| Characteristics | Response |
|---|---|
| Shape | Rod shape |
| Gram staining | Positive |
| Present of spore | Positive |
| Growth temperature | 30° C. to 45° C. |
| pH | 4 to 7 |
| Motility | Positive |

The Isolation of Bacillus megaterium from Fermented Soya Bean Paste

1 gram of sample (fermented soya bean paste) was suspended in 99 ml of sterile distilled water and shaken vigorously for 2 minutes. Then, the culture suspension was serially diluted in sterile distilled water, and the dilutions from 10⁻¹ to 10⁻⁶ were plated on nutrient agar medium. The plates were incubated at 28° C. to 37° C. for 24-48 hours. The isolated bacteria were identified.

In the identification tests of strains, spore morphology, gram characteristics, motility, growth requirement (pH and temperature) were examined.

### Example 2

Determination of Characteristics of Lactobacillus sp

Characteristics of Lactobacillus sp

| Characteristics | Response |
|---|---|
| Presence of oxygen. | positive |
| Gram staining | Positive |
| Presence of endospore | Negative |
| Growth temperature | 30° C. to 40° C. |
| pH | 3.5 to 7 |
| Acid production | Positive, lactic acid |

The Isolation of Lactobacillus sp. from Yogurt

1 gram of sample (yogurt) was suspended in 99 ml of sterile distilled water and shaken vigorously for 2 minutes. Then, the culture suspension was serially diluted in sterile distilled water, and the dilutions from 10⁻¹ to 10⁻⁶ were plated on nutrient agar medium. The plates were incubated at 28° C. to 37° C. for 24-48 hours. The isolated bacteria were identified.

In the identification tests of strains, spore morphology, gram characteristics, motility, growth requirement (pH and temperature) were examined.

### Example 3

Media Used for Production of Microbes

Azar, Powder
Description: Purified and free foam inhibitor
Brand: All brands can be used as long as it is purified and free from inhibitor. Commonly used brand by the company—SIGMA, MERCK or JUNSEI

Nutrient Broth
Description: For microbiology/microbes cultivation
Typical composition: Peptone from meat 5.0
   Meat Extract 3.0
Brand: All brands can be used as long as it is purified and free from inhibitor. Commonly used brand by the company—SIGMA, MERCK or JUNSEI

Ammonium Sulfate (NH₄)₂SO₄

Description: Maximum impurities

| Solubility in water | to pass test |
|---|---|
| Ignition residue (as sulfate) | 0.05% |
| pH (5[w/v]%, 25° C.) | 4.5˜6.0 |
| Free acid | to pass test |
| Chloride (Cl) | 0.002% |
| Nitrate (NO₃) | to pass test |
| Sulfate (SO₄) | 0.002% |
| Phosphate (PO₄) | 0.001% |
| Heavy metals (as Pb) | 0.002% |
| Iron (Fe) | 0.001% |
| Arsenic (As) | 0.0005% |

Brand: All brand can be used as long as it is purified and free from inhibitor.
Commonly used brand by the company—SIGMA, MERCK or DUKSAN

Glucose
Description: pure glucose

Yeast Extract
Description: Water-soluble portion of autolyzed yeast containing vitamin B complex.
   For used in preparing microbiological culture media
Brand: Commonly used brand by the company—SIGMA, MERCK or DIFCO.

Sodium Phosphate, Monobasic (NaH₂PO₄).2H₂O
Description: Assay . . . above 98.0%
Brand: Commonly used brand by the company—SIGMA, MERCK or YAKURI PURE CHEMICALS.

Potassium Phosphate, Dibasic K₂HPO₄

| Description: | Solubility in water | to pass test |
|---|---|---|
| | Drying loss (at 110° C.) | below 2% |
| | pH (0.1 mol soln; at 25° C.) | 8.6-9.3 |
| | Chloride (Cl) | below 0.002% |
| | Nitrate | to pass test (NO₃: |
| | below about 0.001%) | |
| | Sulphate (SO₄) | below 0.005% |
| | Carbonate | to pass test |
| | Heavy metal (as Pb) | below 0.001% |
| | Iron (Fe) | below 0.001% |
| | Calcium (Ca) | below 0.03% |
| | Sodium | below 0.5% |
| | Arsenic (As) | below 0.0002% |
| | Ammonium | below 0.001% |
| | Assay (after drying at 110° C.) | 99.0-100.5% |

| | |
|---|---|
| Brand: | Commonly used brand by the company - SIGMA, |
| | MERCK or YAKURI PURE CHEMICALS. |

### Example 4

Second Seed—Conventional Process

In this process, stock containing microbes (either Bacillus megaterium or Lactobacillus sp) is independently prepared. The working stock used in the present invention is 3.5 liter (L). The stock comprises:

| | | Working |
|---|---|---|
| | Working stock range | stock (%) |
| Glucose | 2% to 3% | 3% [w/v] |
| Ammonium Sulfate | 0.2% to 0.4% | 0.3% [w/v] |
| Potassium Phosphate (monobasic) | 0.1% to 0.3% | 0.2% [w/v] |
| Potassium Phosphate (dibasic) | 0.09% to 0.2% | 0.1% [w/v] |
| water soluble Yeast Extract | 0.2% to 0.4% | 0.3% [w/v] |
| Water | 91% to 98% | 96.1% [v/v] |
| Bacillus megaterium or | 0.7% to 0.9% | 0.8% [v/v] |
| Lactobacillus sp | | |
| Ammonium Water | — | 20% [v/v] |
| Antifoam | — | 15% [w/v] |
| Peptone | 0.05% to 0.015% | 0.09% [w/v] |

### Example 5

Second Seed—Non-Conventional Process

In this process, stock containing microbes (either Bacillus megaterium or Lactobacillus sp) is independently prepared. The working stock used in the present invention is 10 liter (L). The stock comprises:

| | Working | Working |
|---|---|---|
| | stock range | stock (%) |
| Glucose | 1% to 2% | 1.2% [w/v] |
| Ammonium Sulfate | 0.1% to 0.2% | 0.12% [w/v] |
| Potassium Phosphate (monobasic) | 0.03% to 0.05% | 0.04% [w/v] |
| Potassium Phosphate (dibasic) | 0.03% to 0.04% | 0.035% [w/v] |
| Water Soluble Yeast Extract | 0.04% to 0.06% | 0.05% [w/v] |
| Water | 93% to 99% | 98.56% [v/v] |
| Bacillus megaterium or | 0.07% to 0.09% | 0.08% [v/v] |
| Lactobacillus sp | | |
| Antifoam | 0.03% to 0.05% | 0.04% [v/v] |
| Peptone | 0.06% to 0.15 | 0.09% [w/v ] |

### Example 6

Fermented PKC

The ratio to produce 1 metric ton (mt) of fermented PKC is as follows:

| | Working | Working |
|---|---|---|
| | stock range | stock (%) |
| 1 mt of screened raw PKC | 65% to 72% | 68.49% w/w |
| 5 liter of Bacillus megaterium seed | 0.2% to 0.5% | 0.34% [v/w] |
| 5 liter of Lactobacillus sp. seed | 0.2% to 0.5% | 0.34% [v/w] |
| Ash | 1% to 4% | 2.05% w/w |
| Water | 27% to 49% | 28.7% [v/w] |

The foregoing examples demonstrate experiments performed and contemplated by the present inventors in making and carrying out the invention. It is believed that these examples include a disclosure of techniques which serve to both apprise the art of the practice of the invention and to demonstrate its usefulness. It will be appreciated by those of skill in the art that the techniques and embodiments disclosed herein are preferred and non-limiting embodiments only, and that in general numerous equivalent methods and techniques may be employed to achieve the same result. While this invention has been particularly shown and described with references to preferred embodiments thereof, it will be understood by those skilled in the art that various changes in form and details may be made therein without departing from the scope of the invention encompassed by the appended claims.

We claim:

1. A method of producing fermented Palm Kernel Cake (PKC) in a Solid Substrate Fermentation comprising the steps of providing separate cultures of Bacillus megaterium and Lactobacillus sp., mixing said cultures with Palm Kernel Cake at a pH between 5 and 7.5 to produce a mixture, and curing said mixture to produce fermented Palm Kernel Cake.

2. The method of claim 1, wherein said fermented Palm Kernel Cake is dried to produce a dried fermented Palm Kernel Cake.

3. A method of producing a dried fermented Palm Kernel cake (PKC) in a Solid Substrate Fermentation comprising the steps of:
a) separately activating stocks of Bacillus megaterium and Lactobacillus sp.;
b) separately culturing Bacillus megaterium and Lactobacillus sp.;
c) obtaining separate first seed stock cultures of Bacillus megaterium and Lactobacillus sp. from step (b);
d) utilizing separate said first seed stock cultures of Bacillus megaterium and Lactobacillus sp. from step (c) for second seeding or multiplying process to obtain second seed stock cultures;
e) mixing said second seed stock cultures with raw PKC and maintaining the pH range between 5 to 7.5 to produce a fermented PKC;
f) curing said fermented PKC to produce a cured fermented PKC; and,
g) drying said cured fermented PKC to yield a dried fermented Palm Kernel Cake.

4. The method as claimed in claim 3, wherein in step (d), said separate second seed culture stock comprises:
a) a first seed stock culture of Bacillus megaterium and/or a first seed stock culture of Lactobacillus sp;
b) glucose;
c) ammonium sulfate;
d) potassium phosphate (monobasic);
e) potassium phosphate (dibasic);
f) water soluble yeast extract;
g) water;
h) foam control agent;
i) peptone; and,
j) optionally, ammonium water.

5. The method of claim 3, wherein in step (e), the pH is adjusted by addition of ash.

6. The method of claim 5, wherein said mixing of Bacillus megaterium and Lactobacillus sp. seed with raw PKC having a stock comprises:
a. raw PKC,
b. Bacillus megaterium seed,
c. Lactobacillus sp. seed, and
d. Ash.

7. The method of claim 3, wherein said dried fermented Palm Kernel Cake has a final water content of 12% or less.

8. An animal feed comprising fermented PKC product produced by the method of claim 2.

9. The animal feed of claim 8, useful for monogastric animals.
